(19) United States
(12) Patent Application Publication
(10) Pub. No.: US 2024/0072696 A1
(43) Pub. Date: Feb. 29, 2024

(54) MONITORING, CONTROLLING, OR MONITORING AND CONTROLLING AN ELECTRO-MECHANICAL DEVICE

(71) Applicants: Vincent Malik, München (DE); Mohamed Khalil, München (DE); Christoph Ernst Ludwig, München (DE); Dimitrios Loukrezis, München (DE); Dominik Zacharias, Fürth (DE); Matthias Erlwein, Eggolsheim OT Weigelshofen (DE); Christian Andreas Wolf Pozzo, Zirndorf (DE)

(72) Inventors: Vincent Malik, München (DE); Mohamed Khalil, München (DE); Christoph Ernst Ludwig, München (DE); Dimitrios Loukrezis, München (DE); Dominik Zacharias, Fürth (DE); Matthias Erlwein, Eggolsheim OT Weigelshofen (DE); Christian Andreas Wolf Pozzo, Zirndorf (DE)

(21) Appl. No.: 18/239,731

(22) Filed: Aug. 29, 2023

(30) Foreign Application Priority Data
Aug. 30, 2022 (EP) 22192834.4

(51) Int. Cl. H02P 6/34; H02P 6/08; H02P 23/14

(52) U.S. Cl. CPC H02P 6/34; H02P 6/08; H02P 23/14

(57) ABSTRACT

A computer-implemented method of monitoring and/or controlling an electro-mechanical device, such as an electrical motor and/or generator, includes determining a first probability distribution of a virtual measurement variable, such as temperature at a predetermined position, of the electro-mechanical device. A confidence level is determined for a first value of the virtual measurement variable based on the first probability distribution. An operating mode of the electro-mechanical device is changed based on the confidence level, and/or an indication is displayed on a display. The indication instructs a user to change the operating mode of the electro-mechanical device.

This application claims the benefit of European Patent Application No. EP 22192834.4, filed on Aug. 30, 2022, which is hereby incorporated by reference in its entirety.

### TECHNICAL FIELD

The present disclosure relates to monitoring and/or controlling of an electro-mechanical device, such as an electrical motor or generator.

### BACKGROUND

Heat dissipation is an important issue in designing electro-mechanical systems, such as electrical motors and generators. Electrical losses play a major role in heat dissipation and are the major mechanism ruling the thermal behavior of the electro-mechanical system. The electro-mechanical systems are to be designed, monitored, and/or controlled in order to prevent overheating, which may lead to system failure.

Accurate description of the thermal behavior of the electro-mechanical system may be beneficial in terms of thermal management, system utilization, and thermal protection of the electro-mechanical system. Electrical motors are one of the most important energy conversion systems used in industry today (cf., European Patent Application EP1959532A1).

From European patent application EP 21179858, a method and machine control for temperature monitoring of an electro-mechanical device based, for example, on electrical operating data of the device have become known. Based on the operating data, electrical energy losses in the device may be continuously simulated in a spatially resolved manner using a simulation model of the device.

Electro-mechanical devices, such as motors and/or generators, are to operate within a specified range of temperature, and if the electro-mechanical devices are overheated, the motors, for example, run the risk of demagnetization of the magnets and/or the stator winding. Failure of an electro-mechanical device may result in failure not only of the motor but of a whole production system. In order to avoid possible overheating failures of electrical motors, different kinds of thermal protection sensors are used.

From US patent application US2022163952A1, and patent family member EP3715982A1, a method for providing a virtual sensor in an automation system of an industrial system has become known. A data set that has been generated using a simulation model is provided, where the data set produces a unique relationship between possible measurement values of the physical sensor and corresponding output values of the virtual sensor.

### SUMMARY AND DESCRIPTION

The scope of the present invention is defined solely by the appended claims and is not affected to any degree by the statements within this summary.

Monitoring a measurement variable such as a temperature of every critical internal component in an electro-mechanical device is rather costly and may be impossible, as the electro-mechanical device may have to be dismantled in order to place a sensor at the desired positions. The present embodiments may obviate one or more of the drawbacks or limitations in the related art. For example, an optimal or critical operating mode of an electro-mechanical system may be determined. As another example, a simulation model may be adapted for a plurality of similar yet different electro-mechanical device. As yet another example, simulation model inaccuracies that, for example, lead to unacceptable calculation errors may be determined. As another example, calculation errors of the simulation model of an electro-mechanical device may be quantified and/or reduced, for example, in order to improve operation of the electro-mechanical device.

### BRIEF DESCRIPTION OF THE DRAWINGS

FIG. 1 shows an illustration of an electro-mechanical device including a panel for monitoring and/or controlling operation of an electrical motor.

FIG. 2 shows an illustration of components of a motor.

FIG. 3 shows a simulation model of a motor, where the simulation model describes an electrical loss.

FIG. 4 shows a further simulation model of a motor, where the simulation model describes a heat transfer.

FIG. 5 shows yet another simulation model of a motor, where the simulation model combines the electrical loss model with the heat transfer model.

FIG. 6 shows an example of method acts according to a first embodiment in an offline phase.

FIG. 7 shows an example of method acts according to a second embodiment in a calibration phase.

FIG. 8 shows an example of method acts according to a third embodiment in an operation phase.

FIG. 9 shows an illustration of propagation of uncertainty through a simulation model.

FIG. 10 shows an illustration of an inverse Bayesian analysis.

FIG. 11 shows an illustration of different confidence levels.

FIGS. 12 to 18 show method acts according to further embodiments.

### DETAILED DESCRIPTION

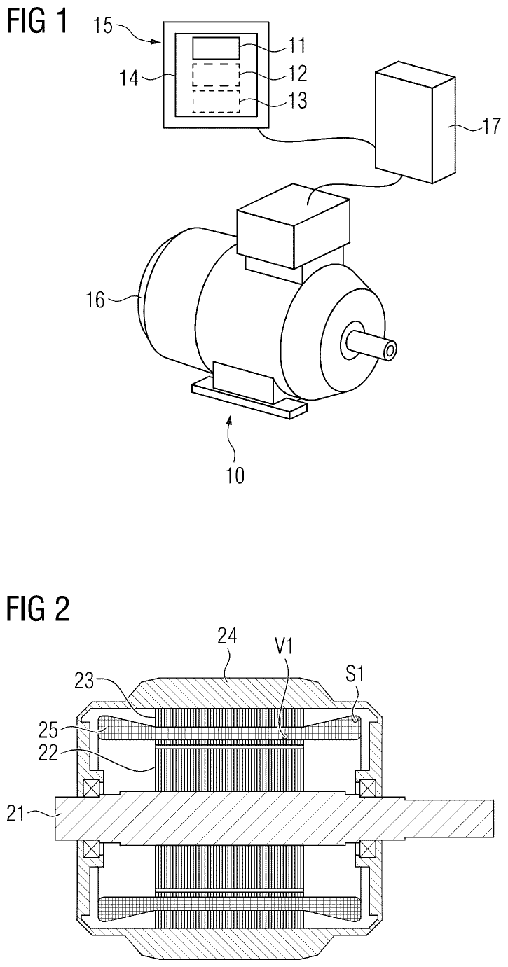

In FIG. 1, an illustration of an electro-mechanical device including an electrical motor 16, a converter 17, and a panel 15 for monitoring and/or controlling operation of the electro-mechanical device 10 is shown.

To detect optimal or critical operating conditions of the motor 16, knowledge of one or more measurement variables (e.g., a temperature) of components of the motor (e.g., bearing, stator, and stator winding insulation) may be necessary.

Monitoring the temperature of every critical internal component in the motor 16 is rather costly and may be impossible, as the motor 16 would need to be dismantled to place the sensors. Alternatively, a more cost-effective approach is virtual sensing, an approach through which measurement variables, such as temperatures, at unmeasured positions in the electro-mechanical device (e.g., the motor 16) may be estimated using a simulation model.

Thus, in case the measurement variable such as the temperature of a motor component cannot be measured (e.g., due to moving parts or if measurements are economically inconvenient), one or more virtual sensors are used to estimate the temperatures. A virtual sensor may thus provide a virtual measurement variable. The virtual measurement variable may provide measurement values (e.g., virtual measurement values at a predetermined position of the electro-mechanical device).

To develop such virtual sensors, the precise knowledge of the motor geometry, material properties, and/or operating parameters may be required. Based on this knowledge, simulation models (e.g., dynamic simulation models) may be created. These simulation models are also referred to as virtual sensors. The simulation model may thus serve to calculate a virtual measurement variable, such as the temperature, at a certain, predetermined position of the motor 16.

For example, in case of electro-mechanical devices such as third-party and/or brownfield motors, the required parameters, such as geometry and material properties, are typically not available. The usage of simulation models of similar motors may thus not be feasible, as simulation model inaccuracies may lead to unacceptable calculation errors. Therefore, a method for quantifying and reducing the calculation errors arising in virtual sensors for electro-mechanical system (e.g., third-party motors) is to be provided.

In FIG. 1, a panel 15 for monitoring and/or controlling the operation of the electrical motor 16 is shown. The panel 15 may include a display 14 for displaying an indication 13 about an operating state of the electro-mechanical device 10 and, for example, the motor 16. Further, the display 14 may serve for controlling the operating state of the electro-mechanical device 10. For example, a first operating mode may be selected by a button 11 (e.g., virtual button), whereas a second button 12 (e.g., virtual button) may serve for selecting a second operating mode. As shown in FIG. 1, the motor is controlled by a converter 17.

FIG. 2 shows an illustration of components of a motor. More precisely, FIG. 2 shows a longitudinal section of a motor. Thereby, a plurality of motor components become visible. An electro-mechanical device such as a motor, may include a shaft 21, a rotor 22, a stator 23, and/or a housing 24.

Due to its operation principles, a motor encounters energy losses in the windings 25 and the rotor 22 as an electrical current flows through the windings 25 and the rotor, and in the stator iron 23 (e.g., core) and the rotor 22 due to electromagnetic phenomena (e.g., hysteresis and eddy currents), as well as energy losses due to current flow. Additionally, relative motion between the components of the bearing assembly result in some energy losses due to friction.

Excessive or anomalous operation of the motor may lead to high levels of energy losses and undesired rise in temperature, which may be alarming to the performance and lifetime of critical components, such as the bearings and the windings. An accurate simulation model of the motor is thus to be provided in order to monitor and/or control operation of the motor. A plurality of simulation models may be combined. For example, a simulation model for calculating heat transfer from the mentioned heat sources to other bodies (e.g., shaft and housing) of the motor and a simulation model for precisely calculating thermal losses at each given heat source based on the operating parameters may be combined.

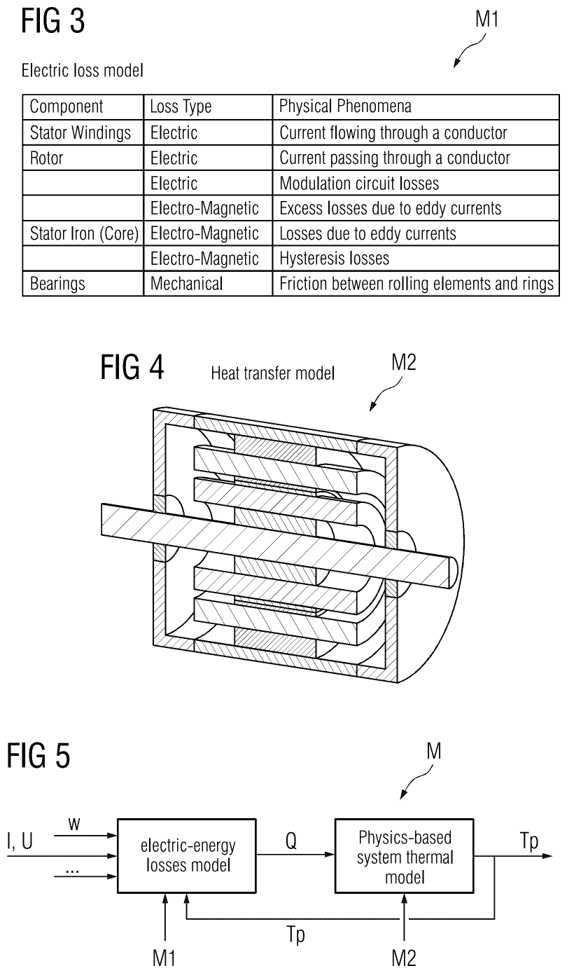

FIG. 3 shows a simulation model M1 of a motor, where the simulation model M1 describes an electrical loss. The electric losses of the motor may be described numerically based on the underlying physical phenomena, as shown in FIG. 3.

FIG. 4 shows a further simulation model M2 of a motor, where the simulation model describes a heat transfer. The simulation model M2 includes different heat transfer modes, such as conduction, convection, and/or radiation. Conduction is observed between components of the motor and/or within the component(s) itself(themselves). Convection is observed at the outer surface(s) of the housing, shields, and/or the exposed part of the shaft. Through convection, heat energy may be dissipated to the environment.

The heat dissipation of the internal components of the motor may be modelled using conduction, while the outer surfaces may be modelled to dissipate heat energy to the environment via convection.

The dimensions of the internal components may be based on a CAD model of the electro-mechanical device. The simulation model M2 may thus be automatically generated by providing the dimensions from an engineering drawing of the electro-mechanical device. Thus, the simulation model, as shown, for example, in FIGS. 3 and 4, may be parametric. Thereby, the simulation model parameters may be adapted in order to fit to different variants of the motor (e.g., different sizes). To facilitate the simulation model parametrization, geometric details, such as spatial features from CAD, may be used.

Further simulation model parameters, for example, for the heat transfer, may include the material properties of a component (e.g., specific heat, density, and thermal conductivity), the mass/volume of the component, surface of heat transfer between components, heat transferred for a unit temperature difference per unit area, and/or area between the body and fluid through which heat is transferred (e.g., area exposed to the fluid flow).

Some simulation model parameters depend on the rotation speed of the motor and the load, or operation values in general.

FIG. 5 shows yet another simulation model M of a motor, where the simulation model M combines the electrical loss model M1 with the heat transfer model M2. As shown, inputs to the heat transfer model are the thermal losses Q (also referred to as electric-energy losses) at the respective components, and the output of the heat transfer model is a temperature measurement value Tp. Hence, based on the simulation model(s) M, M1, M2, a virtual measurement variable and corresponding measurement values may be obtained (e.g., at a predetermined position of the motor).

The inputs of the electric-energy loss model M1 may include dynamic parameters such as a rotational speed w of the shaft and/or a current I and voltage U supplied to the motor. Further dynamic inputs, such as the torque-forming current, to the electric-energy loss model M1 are possible. Further, static inputs such as one or more coefficients (e.g., linear coefficients) may be possible. The simulation model M may depend on these parameters for modelling the behavior of the motor (e.g., linearly or using higher-order polynomials). For example, Siemens proffers a simulation platform “Simcenter Amesim”, which allows system simulations in order to virtually assess and optimize the performance of, for example, electro-mechanical systems. Such a simulation platform may combine multi-physics libraries for creating simulation models M in order to accurately perform a system analysis. This simulation platform may be coupled with computer-aided engineering (CAE), computer-aided design (CAD), and controls software packages of the electro-mechanical system.

The thermal losses model M1 (also referred to as an electric-energy loss model) may require rotor and stator temperatures Tp. These operating values may be obtained, for example, from reading parameters of the motor (e.g., r632 and r633 parameters from SINAMICS). Alternatively or additionally, the respective temperature Tp may be obtained from the thermal model M2 as shown.

As shown in FIG. 5, the electric-energy loss model M1 is interconnected with the physics-based thermal model M2. The electromagnetic losses model M1 calculates the thermal losses using the frequency converter input. As illustrated, the rotational speed w, current I, and voltage U are combined with the geometric and/or material properties (e.g., from the motor data sheet) and the temperature field Tp from the thermal model. Out of the electromagnetic losses, the model M1 may estimate the heat generation (e.g., heat load, Q) within the motor. Q is the input for the thermal model M2, which may calculate the temperature distribution in the model.

Both simulation model(s), such as the thermal losses model M1 and the heat transfer model M2, may be packed in a functional mock-up unit (FMU) format in order to be deployed and/or executed. The input and outputs of the simulation model(s) (e.g., thermal losses and temperatures) may be placed as outputs and inputs to an FMU interface.

In any case, the simulation model-based virtual sensors may not be used for monitoring without the exact knowledge of the required geometric data. The simulation models are to be verified against measured data, and therefore, the rollout may take prolonged time. Further, the quality of the parameterization of the motor may be rather inaccurate, and thus, the parameters obtained from the motor itself may be unreliable. Thus, usually and whenever possible and financially sensible, physical sensors have been used in order to determine a condition of a motor.

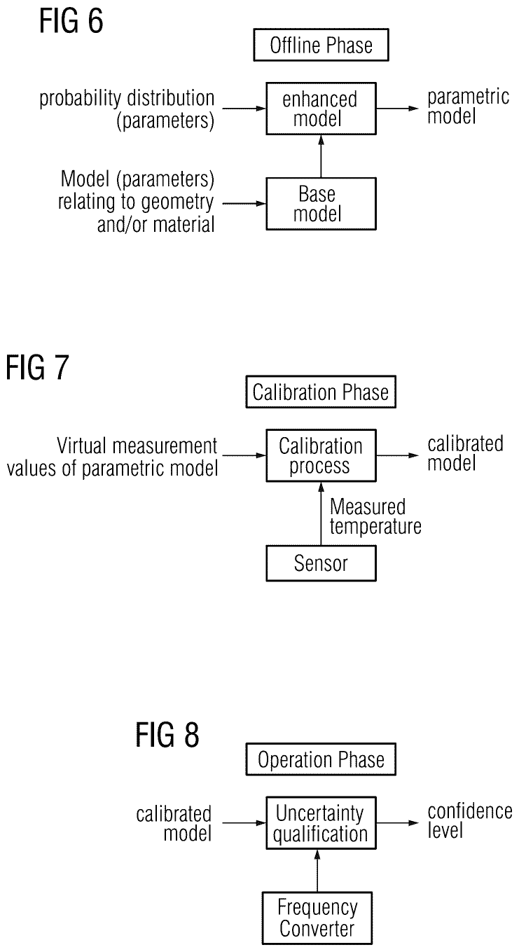

FIG. 6 shows an example of method acts according to a first embodiment (e.g., during an offline phase). A simulation model is created based on simulation model parameters relating to the geometry and/or material of the motor. These parameters and their values may be known from the data plate or a data sheet of the motor. For example, the simulation model, as described in connection with FIGS. 3, 4 and/or 5, may be used. Thus, a base model is enhanced with the specific values of the simulation model parameters. As a result, an enhanced model is obtained. Now, one or more of the simulation model parameters may be represented by assigning a probability distribution to the one or more simulation model parameters. The probability distribution corresponds, for example, to a prior distribution. The probability distribution may be a distribution of a certain type, such as a Gaussian distribution or Poisson distribution. The probability distribution itself may be parameterized by setting the statistical moments, such as the mean value, the variance, or standard deviation, of the respective simulation parameter. The statistical moment(s) may be obtained from the motor manufacturer, the component manufacturer, and/or known from experience, and may be due to the variation in the production of the motor or motor component. For example, material properties (e.g., of a component) are subject to variation. As a result, a parametric simulation model is obtained.

FIG. 7 shows an example of method acts according to a second embodiment (e.g., during a calibration phase of the simulation mode)l. To that end, the position of the virtual measurement variable may be chosen to coincide with the position of the one or more actual sensors. The parametric simulation model may be calibrated. For example, to calibrate the convection coefficients in the simulation model, sensors (e.g., reference sensors) mounted on both bearings near the outer rings, on each wiring phase at the winding ends, and/or at the housing to measure the ambient temperature may be used. Then, different load cases are applied to the motor, with variant speeds and torques. Based on the actual measurements, the convection coefficients of the simulation model may be adjusted in order to achieve a minimal difference between the simulated temperature values and the actual measurement values.

As shown in FIG. 7, one or more virtual measurement values are obtained as an output of the parametric model. In addition, measurement values (e.g., real measurement values) are measured at one or more positions by a sensor (e.g., a reference sensor) on the motor. The measurement values (e.g., real measurement values) are then compared to their corresponding virtual measurement values obtained from the simulation.

For the calibration, the difference between the measurement values (e.g., real measurement values) and the virtual measurement values are determined in order to adapt the simulation model parameters and/or the probability distribution parameters accordingly. This adaptation may be performed incrementally until the difference is below a predetermined threshold.

During the calibration, information about uncertainty in the simulation model parameters (e.g., geometrical and material tolerances) is retained. Those uncertainties, reflected by the probability distribution (e.g., parameters) may be updated based on the actual measurement values in order to obtain the most likely simulation model parameters. An uncertainty quantification (e.g., inverse uncertainty quantification) is employed, also referred to as inverse Bayesian analysis. An inverse uncertainty quantification is based on actual measurement values, in this case of an electro-mechanical device, and the simulation model results (e.g., the virtual measurement values). The inverse uncertainty quantification estimates the discrepancy between the actual measurements and the virtual measurement values of the simulation model, and estimates the most likely simulation model parameters (and their respective values). Hence, this phase is referred to as a calibration phase. Thus, a calibration phase that may provide a calibrated simulation model and a corresponding uncertainty quantification mechanism is provided. Hence, a simulation model that controls the motor may be created using, for example, only the information provided by the frequency inverter, as depicted in FIG. 1. This simulation model may be used to calculate the virtual measurement variables, such as temperatures, of one or more critical components and/or at one or more predetermined positions.

FIG. 8 shows an example of method acts according to a third embodiment (e.g., an operation phase). After the calibration phase, the updated simulation model (e.g., calibrated model) is obtained. The calibrated model may be used as a virtual sensor. The virtual sensor provides virtual (e.g., simulated) measurement values. In addition, the virtual sensor may provide a related confidence level, or confidence interval, for measurement variables, such as temperatures, of interest. A confidence interval may be obtained by considering an uncertainty in the simulation model parameters (e.g., which result from the calibration phase). The uncertainties in the virtual measurement variable may be obtained based on an uncertainty propagation.

Hence, the temperature at arbitrary positions (e.g., at one or more predetermined positions) of an electro-mechanical device (e.g., in a motor) may be calculated. No initial and/or precise knowledge of the required simulation model parameters such as geometry and/or material properties is required. The uncertainty of the simulation model parameters is given by a probability distribution. Based on this probability distribution, virtual measurement variables and corresponding values may be determined using the simulation model.

The motor as described herein is just an example of an electro-mechanical device. Other electro-mechanical devices may include a generator, a relay, a pump, an electrified vehicle, an aircraft, a ship, or a train.

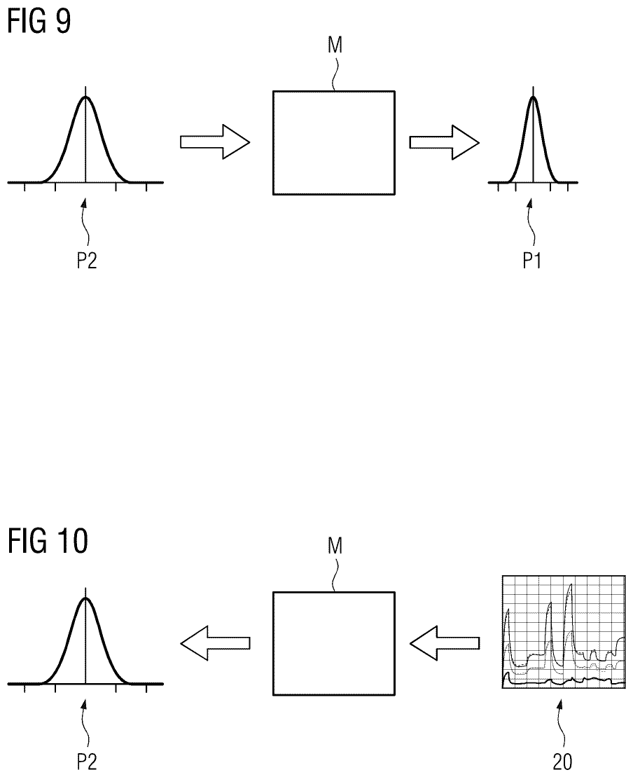

FIG. 9 shows an illustration of propagation of uncertainty through a simulation model M (e.g., forward model). This uncertainty propagation may be used when calibrating the simulation model M (e.g., as described in connection with FIGS. 3, 4 and/or 5). A first probability distribution P1 may be obtained. The first probability distribution P1 may be a response of the simulation model M to a second probability distribution P2 that serves as input for the simulation model M. The probability distribution P1 may be inferred from a set of observed model responses to the input. The probability distribution P1 and/or P2 may be of a certain type (e.g., Gaussian), and may be given/identified by its mean value and its variance and/or further statistical moments. The probability distributions may then be fitted.

The second probability distribution may be initially parameterized (e.g., based on expert knowledge). For example, the second probability distribution may be a Gaussian distribution with mean value and variance. The expert knowledge may be reflected in this initial parameterization by setting a variance of the distribution describing the simulation model parameter according to past experience and/or examined properties. For example, it may have been observed that the material properties deviate from the originally provided values to a certain degree.

FIG. 10 shows an illustration of an inverse Bayesian analysis. A second probability distribution may be inferred from a set of measurement values 20 (e.g., real measurement values 20). Thus, a most probable value of a simulation model parameter may be determined. These optimized simulation model parameters may be used for updating the simulation model, thus yielding an optimized simulation model. Subsequently, when the simulation model is in operation, one or more anomalies may be determined (e.g., based on the confidence level of the virtual measurement value(s)), and thus, the operation of the electro-mechanical device may be controlled.

The simulation model calibration serves for determining unknown or uncertain properties of the electro-mechanical device and/or of one or more of its components. The calibration may be performed based on the measurement values (e.g., real measurement values) from a sensor (e.g., reference sensor). The reference sensor may be located at a known position of the electromechanical device, as, for example, shown in FIG. 2.

After the calibration phase, the inferred simulation model parameters (and corresponding values) and, for example, the uncertainty of the inferred simulation model parameters may be used to determine the behavior of the electro-mechanical device (e.g., determine virtual measurement variable at a predetermined position (other than the one of the (reference) sensor)).

In general, the simulation model may be understood as a computational model. The simulation model may output one or more measurement values (e.g., virtual measurement values) of a virtual measurement variable. The virtual measurement variable may not be directly measurable by an actual sensor due to the equipment, structure, and/or assembly of the electro-mechanical device. The simulation model may calculate virtual measurement values based on input values. The input value(s) may be the currently available operating values of the electro-mechanical device. As described, the currently available operating values may be obtained from the electro-mechanical device, such as a motor and/or converter.

There may be a discrepancy between the actual measurement values and the virtual measurement values. This discrepancy is interpreted as a simulation model inaccuracy. The discrepancy may be minimized by finding the simulation model parameters that best fit the actual measurement values. Thus, the actual measurements are inverted through the simulation model M. As a result, a posterior, second probability distribution P2 may be obtained. The statistical moments, such as mean and/or variance, of the posterior, second probability distribution may be interpreted as point estimates of the simulation model parameter (e.g., a most probable value of the simulation model parameter). Thus, the second probability distribution P2 and/or the most probable value of the simulation model parameter may be used for determining virtual measurement values of a virtual measurement variable. To that end, the second probability distribution and/or the most probable value of the simulation model parameter(s) may be used to parameterize or reparameterize the simulation model (e.g., again) in order to determine virtual measurement values of a virtual measurement variable.

In order to determine the updated second probability distribution, a type of probability distribution, such as a Gaussian distribution, and/or a parameterization thereof, such as a mean value and variance, may be specified. This probability distribution may be an input object (e.g., of the UQLab software). The simulation model may also be created (e.g., using the UQLab software), as an m-file. Finally, the actual measurements from a sensor (e.g., reference sensor) may be obtained and, for example, stored in matrix form. Subsequently, an inverse Bayesian analysis may be performed (e.g., again using UQLab software by calling the function uq_createAnalysis( )). As a result of the inverse Bayesian analysis, updated simulation model parameters may be obtained. The updated simulation model parameters may be given by the updated second probability distribution P2 and its parameters, such as updated mean, variance, and/or other statistical moments. Further, for example, for the sake of visualization, the second probability distribution may be fitted and/or plotted. In any case, the second probability distribution may be given by a type of probability distribution, such as Gaussian, and the corresponding one or more statistical moments.

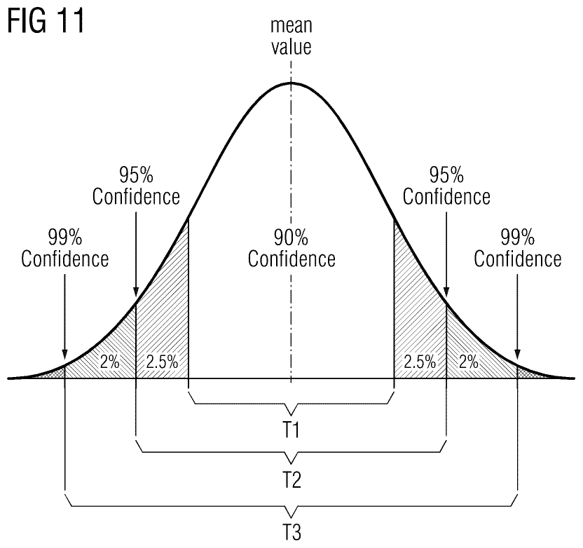

FIG. 11 shows an illustration of confidence levels T1, T2, T3. A confidence level (e.g., a confidence interval) for the virtual measurement variable may be determined based on the first probability distribution. The confidence level indicates a level of accuracy that the true value of the virtual measurement variable is within the confidence interval. Thus, a reliability of the simulation model and the virtual measurement variables obtained as an output of the simulation model is obtained. FIG. 11 shows the distribution of measurement values (e.g., virtual measurement values) around a mean value. The virtual measurement values may be obtained based on the simulation model. As shown in FIG. 11, different confidence levels T1, T2, T3 are possible. A user may select a confidence level according to a desired accuracy for monitoring the electro-mechanical device. For example, the confidence level may correspond to a confidence interval of, for example, 90%, 95%, or 99%.

For example, after the calibration phase, the updated simulation model (e.g., of the electro-mechanical device) is used as a virtual sensor and yields simulated values and related confidence intervals for critical temperatures of interest (e.g., based on the operating values of the electro-mechanical device such as speed, current, and/or voltage). The confidence intervals may be obtained by considering the uncertainties in the simulation model parameters (e.g., which result from the calibration phase) within appropriate uncertainty propagation methods. The confidence level or confidence interval may, for example, be estimated based on a discrepancy function between the simulation model output and the actual measurement value determined during the calibration phase. Hence, a confidence level may be provided as a quantification of the uncertainty of the virtual measurement variable and/or its values. The confidence level may be understood as the percentage of the intervals that contain a virtual measurement value.

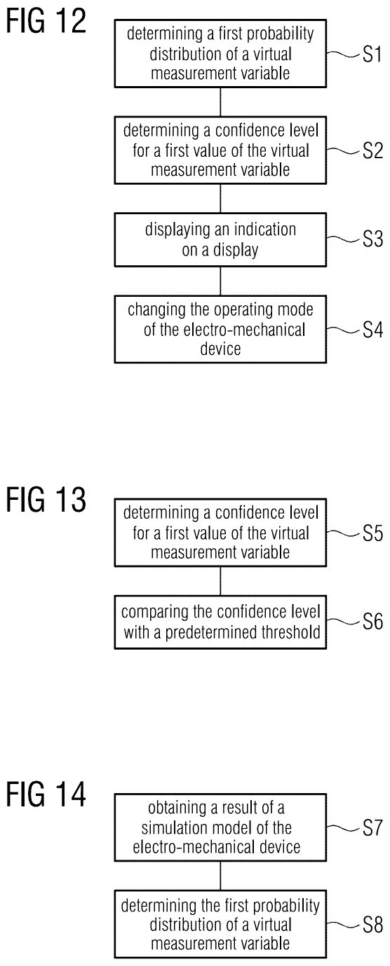

Turning to FIG. 12, method acts according to an embodiment are shown. The method acts may be computer-implemented and may serve for monitoring and/or controlling an electro-mechanical device, such as an electrical motor and/or generator.

In act S1, a first probability distribution of a virtual measurement variable may be determined. The virtual measurement variable may be a temperature at a predetermined position of the electro-mechanical device.

In act S2, a confidence level for a first value of the virtual measurement variable may be determined, for example, based on the first probability distribution.

In act S3, an indication may be displayed on a display (e.g., of the electro-mechanical device or a device communicatively coupled to the elector-mechanical device, such as, a computer-display). The indication may instruct a user to change the operating mode of the electro-mechanical device.

In act S4, the operating mode of the electro-mechanical device may be changed based on the confidence level. Act S3 may be optional, and the change of the operating mode may be automatically performed based on the confidence level (e.g., in case the confidence level exceeds a predetermined threshold, such as is lower than 90%, 95%, or 99%).

The confidence level and the indication of the confidence level displayed includes information about the accuracy of the virtual measurement variable and the virtual measurement value(s). The confidence level thus reflects the reliability of the virtual measurement value(s) and may serve for controlling the operation of the electro-mechanical device (e.g., for controlling the operating mode of the electro-mechanical device). For example, the electro-mechanical device may be operated in a failsafe operating mode, or with lower power in case the confidence level is exceeded.

Turning to FIG. 13, further method acts according to an embodiment are shown. In act S5, for example, after act S1, a confidence level for a first value of the virtual measurement variable may be determined. Hence, a confidence level for each virtual measurement value of a plurality of virtual measurement values of one or more virtual measurement variables may be determined. In act S6, the confidence level may be compared with a predetermined threshold (e.g., 99%, 95%, or 90%). The confidence level may be understood, as described herein, as the probability of exceeding a deviation from a mean (e.g., virtual measurement) value of the virtual measurement variable (e.g., at a predetermined position). Subsequently, the operating mode of the electro-mechanical device may be changed, and/or an indication may be displayed in case the predetermined threshold is exceeded (e.g., as described before in connection with acts S3 and/or S4).

Turning to FIG. 14, further method acts according to an embodiment are shown. In act S7, a result of a simulation model of the electro-mechanical device is obtained. Thus, for example, a plurality of virtual measurement values is obtained as a result of the simulation model. The simulation model may represent a thermal behavior of the electro-mechanical device and/or an electric-loss behavior of the electro-mechanical device. The simulation model may thus be executed, for example, in the calibration phase and/or the operation phase, for a plurality of operating conditions including different operating values (e.g., of rotational speed, current, and/or voltage) of the electro-mechanical device. As a result, a first probability distribution may be determined, for example, in the calibration phase (e.g., by fitting a curve to the results obtained). Thereby, a probability distribution (e.g., continuous probability distribution) for the virtual measurement variable may be obtained.

Further, the first measurement value may be obtained as a result of the simulation model of the electro-mechanical device in act S8 (e.g., in the operation phase). The first measurement value of the virtual measurement variable may be obtained by inputting one or more currently available operating values of the electro-mechanical device into the simulation model. The currently available operating values may be obtained from the electro-mechanical device. For example, the operating values of the electro-mechanical, such as rotational speed, current, and/or voltage, may be obtained from a motor and/or generator and/or converter coupled thereto. Based on these current operational values that may serve as input for the simulation model, the first measurement value may be obtained as an output or result of the simulation model. Thus, the simulation model may include simulation model parameters representing the geometric properties and/or material properties of the electro-mechanical device. At least a part of these geometric and/or material properties may be modelled by a respective second probability distribution.

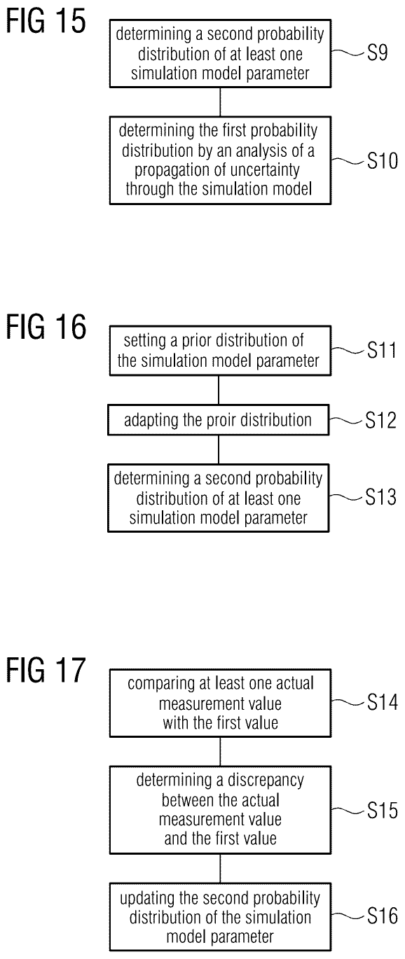

Turning to FIG. 15, in act S9, a second probability distribution of at least one simulation model parameter may be determined. The simulation model parameter is thus itself modelled as a probability distribution. A plurality if not all of simulation model parameters may be modelled by their respective probability distribution. Nonetheless, some simulation model parameters may also be constants. In order to obtain the second probability distribution in the first place, an appropriate probability distribution, such as a Gaussian distribution, Poisson distribution, or the like, that reflects the behavior of the simulation parameter may be chosen. For example, in case of the thermal model of the electro-mechanical device, the probability distribution may reflect a manufacturing error or a manufacturing deviation (e.g., an impurity) of a material used for building the electro-mechanical device.

Now, for example, in the offline phase and/or the calibration phase, the first probability distribution may be obtained by an analysis of a propagation of uncertainty through the simulation model in act S10. Thereby, the effect of an uncertainty of a simulation model parameter on the uncertainty of result of the simulation model (e.g., the virtual measurement variable) may be obtained. A second probability distribution and/or one or more statistical moments, such as the mean, the variance, the skewness, and/or the kurtosis, of the second probability distribution may be determined.

Turning to FIG. 16, further methods acts of an embodiment are described. In act S11, a prior distribution of the simulation model parameter may be set, for example, in the offline phase. As described, the prior distribution (e.g., type) may be chosen appropriately to reflect the properties (e.g., statistical properties) of the simulation model parameter(s). In act S12, the prior distribution may be adapted by setting the mean value and/or the variance of the prior distribution describing the simulation model parameter. As a result, the second probability distribution is obtained in asset S13.

Turning to FIG. 17, further methods acts of an embodiment are described. In act S14, for example, in a calibration phase, at least one actual measurement value is compared with the first value. The actual measurement value may be obtained by a sensor attached to the electro-mechanical device. The sensor may be attached at a known position (e.g., a coiling head) of the electro-mechanical device. Hence, the predetermined position at which the virtual measurement variable is measured may be the same (e.g., essentially the same) as the position of the sensor. Thus, the sensor serves as a reference sensor during a calibration phase of the simulation model. The sensor may also only be temporarily attached to the electro-mechanical device to provide the actual measurement values as a reference for the virtual measurement variable(s).

In act s15, a discrepancy between the actual measurement value and the first value may be determined, for example, by determining a difference. In act S16, the second probability distribution of the simulation model parameter and/or determining a most probable value of the simulation model parameter may be updated. The update may be based on the discrepancy, which represents the simulation model error or inaccuracy.

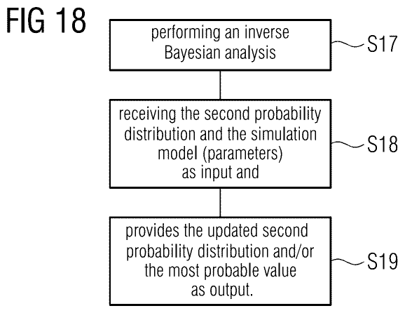

Turning to FIG. 18, further methods acts of an embodiment are described. In act S17, in the calibration phase, for example, an inverse Bayesian analysis is performed (e.g., in order to update the second probability distribution). The inverse Bayesian analysis may be based on the second probability distribution, the simulation model (e.g., parameters), and the actual measurement value(s). The inverse Bayesian analysis may be performed using a software application, such as UQLab, which receives the second probability distribution, the simulation model (e.g., parameters), and the actual measurement value(s) as input and provides the updated second probability distribution and/or the most probable value of the simulation model parameter(s) as output.

The updated, second probability distribution and/or the most probable value of the simulation model parameter(s) may then serve for (re-)parameterizing the simulation model of the electro-mechanical device. Hence, an optimized simulation model of the electro-mechanical device is obtained, that may be used for controlling and/or monitoring of the electro-mechanical device (e.g., in the operation phase, such as during the operation of the electro-mechanical device).

The calibration phase is, for example, advantageous for the calibration of the simulation model in order to initially adapt the simulation model. The calibration phase may also be advantageous in order to adapt the simulation model from one electro-mechanical device to another electro-mechanical device. The calibration phase may also be advantageous in order to adapt an electro-mechanical device with changed thermal behavior of the electro-mechanical device and/or an electric-loss behavior (e.g., after a replacement or maintenance). The calibration phase may also be advantageous in order to adapt the simulation model regularly, event-based, or upon user initialization during the operation of the electro-mechanical device, since the geometric and/or thermal properties of the electro-mechanical device may change during its lifetime due to tear, wear, abrasion, and/or erosion.

The inverse Bayesian analysis propagates the actual measurement values backwards in order to obtain information about the simulation model inputs (e.g., in the present case, about the second probability distribution and the simulation model parameters described by the second probability distribution).

In a further embodiment, a computer program product for monitoring and/or controlling an electro-mechanical device obtained by one or more of the method acts as described herein is proposed.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method of monitoring, controlling, or monitoring and controlling an electro-mechanical device, the method comprising:
determining a first probability distribution of a virtual measurement variable of the electro-mechanical device;
determining a confidence level for a first value of the virtual measurement variable based on the first probability distribution; and
changing an operating mode of the electro-mechanical device based on the confidence level, displaying an indication on a display, or a combination thereof, the indication instructing a user to change the operating mode of the electro-mechanical device.

2. The method of claim 1, wherein the electro-mechanical device comprises an electrical motor, a generator, or the electrical motor and the generator.

3. The method of claim 1, wherein the virtual measurement variable is a temperature at a predetermined position.

4. The method of claim 1, further comprising:
comparing a confidence level with a predetermined threshold; and
changing the operating mode, displaying the indication, or a combination thereof in case, based on the comparing, the predetermined threshold is exceeded.

5. The method of claim 1, further comprising:
obtaining the first value of the virtual measurement variable as a result of a simulation model of the electro-mechanical device.

6. The method of claim 5, wherein the simulation model represents a thermal behavior of the electro-mechanical device, an electric-loss behavior of the electro-mechanical device, or a combination thereof.

7. The method of claim 5, wherein the simulation model comprises simulation model parameters representing geometric properties, material properties, or geometric properties and material properties of the electro-mechanical device.

8. The method of claim 5, further comprising:
determining a second probability distribution, corresponding statistical moments, or the second probability distribution and the corresponding statistical moments of a simulation model parameter of the electro-mechanical device,
wherein determining the first probability distribution comprises determining the first probability distribution by an analysis of a propagation of uncertainty of the second probability distribution through the simulation model.

9. The method of claim 8, wherein determining the second probability distribution of the simulation model parameter comprises setting a prior distribution of the simulation model parameter.

10. The method of claim 9, wherein determining the second probability distribution comprises adapting the prior distribution based on a plurality of values of the simulation model parameter.

11. The method of claim 10, wherein adapting the prior distribution based on the plurality of values of the simulation model parameter comprises fitting the prior distribution to the plurality of values of the simulation model parameter.

12. The method of claim 5, further comprising:
calibrating the simulation model of the electro-mechanical device, the calibrating comprising comparing an actual measurement value of a sensor attached to the electro-mechanical device with the first value.

13. The method of claim 12, wherein the calibrating comprises:
determining a discrepancy between the actual measurement value and the first value; and
updating the second probability distribution of the simulation model parameter. determining a most probable value of the simulation model parameter based on the discrepancy, or a combination thereof.

14. The method of claim 13, wherein updating the second probability distribution comprises performing an inverse Bayesian analysis based on the second probability distribution and the simulation model, using a software application that receives the second probability distribution and the simulation model as input and provides the updated second probability distribution, the most probable value of the simulation model parameter, or a combination thereof as output.

15. The method of claim 12, wherein monitoring, controlling, or monitoring and controlling the electro-mechanical device comprises monitoring, controlling, or monitoring and controlling the electro-mechanical device during operation of the electro-mechanical device.

16. The method of claim 15, further comprising calibrating a simulation model for another electro-mechanical device, for an electro-mechanical device with changed thermal behavior of the electro-mechanical device, an electric-loss behavior, or the changed thermal behavior and the electric-loss behavior, or any combination thereof.

17. The method of claim 15, wherein the calibrating of the simulation model is performed when a deviation between the actual measurement value of the sensor (S1) attached to the electro-mechanical device and the first value of the virtual measurement variable exceeds a predetermined threshold.

18. An apparatus comprising:
a processor and a memory configured to monitor, control, or monitor and control an electro-mechanical device, the processor and the memory being configured to monitor, control, or monitor and control the electro-mechanical device comprising the processor and the memory being configured to:
determine a first probability distribution of a virtual measurement variable of the electro-mechanical device;
determine a confidence level for a first value of the virtual measurement variable based on the first probability distribution; and
change an operating mode of the electro-mechanical device based on the confidence level, display an indication on a display, or a combination thereof, the indication instructing a user to change the operating mode of the electro-mechanical device.

19. In a non-transitory computer-readable storage medium that stores instructions executable by one or more processors to monitor, control, or monitor and control an electro-mechanical device, the instructions comprising:
determining a first probability distribution of a virtual measurement variable of the electro-mechanical device;
determining a confidence level for a first value of the virtual measurement variable based on the first probability distribution; and
changing an operating mode of the electro-mechanical device based on the confidence level, displaying an indication on a display, or a combination thereof, the indication instructing a user to change the operating mode of the electro-mechanical device.
